(19) United States
(12) Patent Application Publication
(10) Pub. No.: US 2026/0119661 A1
(43) Pub. Date: Apr. 30, 2026

(54) DEFINING INDICATORS OF MALICIOUS ACTIVITY BY A MACHINE LEARNED MODEL

(71) Applicant: CrowdStrike, Inc., Sunnyvale, CA (US)

(72) Inventors: Olga Gdula, Reading (GB); Felix Schwyzer, Berlin (DE); Calin-Bogdan Miron, Nottingham (GB); Sandra Servia Rodriguez, Cambridge (GB)

(21) Appl. No.: 18/926,119

(22) Filed: Oct. 24, 2024

(51) Int. Cl. G06F 21/56

(52) U.S. Cl. CPC G06F 21/566; G06F 40/16; G06F 40/216; G06F 40/242; G06F 40/284; G06N 3/08; G06F 2221/034

(57) ABSTRACT

Techniques for determining vector representations of labeled data entities and using those vector representations to detect malicious activity are described herein. A system implementing the techniques receives a vocabulary comprised of data tokens and a set of labeled data entities. The vocabulary includes at least one data token determined based at least in part on user data associated with a user interface and at least one data token determined by a machine learned model. Based on the vocabulary, the system then determines, for at least labeled one data entity of the set of labeled data entities, a vector representation of the at least one labeled data entity. The vector representation indicates presence or counts of data tokens of the vocabulary within the at least one labeled data entity. The system then provides the vector representation for use in detecting malicious activity in data transactions.

### BACKGROUND

With computer and Internet use forming an ever-greater part of day-to-day life, security exploits and cyberattacks directed to stealing and destroying computer resources, data, and private information are becoming an increasing problem. Some attacks are carried out using “malware”, or malicious software, while others may be accomplished simply through malicious activity. Malicious activity can include a variety of different types of cyberattacks, including fileless attacks, and is increasingly obfuscated or otherwise disguised in an effort to avoid detection by security software. Determining whether a program includes malicious activity or is exhibiting malicious behavior can thus be very time-consuming and resource-intensive.

A computer may recognize malicious activity in a data transaction by classifying portions of the data transaction as originating from a threat actor (or not). Before the portions of the data transaction can be classified as originating from such a threat actor, similar or same prior portions of data transactions may be associated with the threat actor by machine intelligence or human-provided configuration or input (i.e., information from a developer or tester). Models can be trained with those similar or same prior portions of data transactions and their associations, but such models may be overly burdensome in terms of processing and time, effecting performance as experienced by a user. Alternatively, regular expressions may be used in a retrospective analysis, missing emerging threats.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a block diagram of using a vocabulary, statistical features, and labeled data entities to determine vector representations of the labeled data entities and of using those vector representations to recognize malicious activity.

FIG. 2 illustrates a diagram of an example security architecture for using a vocabulary, statistical features, and labeled data entities to determine vector representations of the labeled data entities and to use those vector representations to recognize malicious activity.

FIG. 3 is a flowchart depicting an example process for determining, for a labeled data entity, a vector representation that is usable to recognize malicious activity.

FIG. 4 is a block diagram of an illustrative computing device architecture to implement the techniques describe herein.

### DETAILED DESCRIPTION

This application describes techniques for determining vector representations of labeled data entities and using those vector representations to detect malicious activity. A system implementing the techniques receives a vocabulary comprised of data tokens, statistical features associated with the data tokens, and a set of labeled data entities. Based on the vocabulary and statistical features, the system then determines, for at least one labeled data entity of the set of labeled data entities, a vector representation of the at least one labeled data entity. The vector representation indicates presence or counts of data tokens of the vocabulary within the at least one labeled data entity. The system then provides the vector representation for use in detecting malicious activity in data transactions. This can include providing the vector representation to a supervised machine learning model to train the supervised machine learning model to recognize malicious activity in data entities (e.g., command lines, process trees, etc.). The vector representation can also contribute to building neural networks, decision trees, logistic regressions, or other components that can be used to analyze malicious activity.

The vocabulary may include first data tokens representing a first set of human-readable characters and second data tokens representing a second set of human-readable characters. The first data tokens may be determined based at least in part on user data associated with a user interface (e.g., user data entered by a security analyst). The second data tokens may be determined by a machine learned model configured to output the second data tokens based at least in part on an unsupervised algorithm. These first and second data tokens may be combined into a joint vocabulary, and duplicates between the first and second data tokens may be eliminated from that joint vocabulary. It is the joint vocabulary, then, that is used along with the statistical features and labeled data entities to determine the vector representation.

As used herein, a “data token” can include one or more characters or sequences of characters representing a word, a part of a word, a symbol, an image, a number, or the like, that may be human-readable (e.g., understandable and/or interpretable by a human). Characters may or may not be alphanumeric. For instance, human-readable data tokens may include any or all of the following examples: “abcdefgh”, “i.n.”, “934762”, “$env”, “1234.2.3.4”, “\\system32\\”, etc. One or more data tokens comprise a “vocabulary.” In various examples, data tokens may be in a sequence relative to one another to represent a phrase or a command, such as data associated with a command line of a command window. Further, the data tokens can represent data determined based on human expertise in algorithmic language processing, cyber threat analysis, or the like as well as data determined by a machine learned model. In this way, benefits of a human-derived vocabulary can be employed at scale (along with a machine-learned-based vocabulary) rather than relying on human intervention to define the indicators of malicious attack intermittently and/or individually.

“Statistical features”—also referred to as heuristics—can be based at least in part on input from a human (e.g., via a user interface) and can represent statistical features or properties such as a count of characters from a vocabulary. The statistical features may, for example, enable the machine learned model to capture specific features, or information, associated with the vocabulary included in a data entity. Other examples of statistical features include a length of a data entity; a length of a part of a data entity; a number of alphanumeric character strings (e.g., words) in a data entity or in a part of a data entity; an average length, a minimum length, a maximum length, or a standard deviation of length of substrings (e.g. separated by whitespace) in a data entity or in a part of a data entity; a ratio of digits to alphanumeric characters in a data entity or in a part of a data entity; a number of characters associated with a data entity or a part of a data entity; a ratio of digits and counts; a ratio of one type of character to all characters in a data entity or in a part of a data entity; or a ratio of alphanumeric characters to total length of characters in a data entity or in a part of a data entity; etc.

A “data entity”, as used herein, has one or more data tokens and may include a command line, a tree representing a process or decision associated with a computing device, such as a process tree, telemetry data associated with a process running on a computing device, an event indicative of a behavior of interest, etc. “Labeled” data entities may each have one or more labels that may pertain to some part of or all of that data entity. Such labels may in turn have one or more classes of security status, such as “malicious,” “clean”, “unwanted,” etc. As described herein, the one or more labels of a data entity may be associated with the vector representation of that data entity.

“Models” may be representative of machine learned models, statistical models, heuristic models, or a combination thereof. That is, a model may refer to a machine learning model, also referred to herein as a machine learned model, that learns from a training dataset to improve accuracy of an output (e.g., a prediction). Additionally or alternatively, a model may refer to a statistical model that is representative of logic and/or mathematical functions that generate approximations which are usable to make predictions.

As described herein, a “vector representation” represents the presence or count of each of one or more data tokens of a vocabulary or subset of a vocabulary in a labeled data entity. For example, a vector representation of a vocabulary could be [0, 0, 1, 1, 0, 0, 0, 1, 1, 1] with “1” representing presence and “0” representing absence of a data token of that vocabulary in a labeled data entity. Using vector representations rather than relying on a regular expression or other more computationally intensive technique enables the system to define the indicators of malicious activity using fewer computational resources, thus allowing more data entities to be analyzed over time.

In various implementations, when a model (e.g., a neural network, a decision tree, a logistic regression, etc.) or indicator of attack is developed based on the vector representation(s), that structure or data can be used to recognize malicious activity in data transactions that involve data entities, such as command lines (e.g., “c:\windows\system32\cmd.exe”) or process trees. The structure or data can be disseminated to and used at one or more host devices. Such host devices may have models and/or security agents capable of utilizing the received structure or data.

Additionally, the system implementing the techniques described herein can receive new or updated data over time, (e.g., vocabulary from a human and/or model, heuristics, labeled data, etc.) and determine additional indicators of malicious activity as new or updated data is received to enable real-time analysis and detection of new security threats.

In various examples, data output by the system can be stored in a storage device as a “catalog” available to various devices. The system can update, delete, add, or otherwise manage the vocabulary and indicators derived therefrom over time to maintain a list of malicious activity indicators. In various examples, the catalog of malicious activity indicators can be transmitted to the various devices to cause the devices to improve detection of malicious activity occurring on a respective device. In some examples, the stored data (e.g., vocabulary data, indicator data, etc.) can be provided to a security component, a host device, or the like. Also, the system can transmit output data to a host device to cause the host device to improve detection of a security threat.

In some implementations, the system can be implemented as a cloud-based service configured to determine descriptions, security concepts, and the like, that improve subsequent detection of malicious events (e.g., by improving which combinations of data in a data string are indicative of malicious activity). The system can, for example, determine malicious indicators for entities that having no current indicator defined.

In various instances, the system may install, and subsequently execute a security agent on a host device as part of a security service system to monitor and record events and/or patterns on host devices in an effort to detect, prevent, and mitigate damage from malware or malicious activity. In various examples, the security agent may detect, record, and/or analyze events on the host device, and the security agent can send those recorded events (or data associated with the events) to the system. At the system, the received events data can be further analyzed for purposes of detecting, preventing, and/or defeating malicious activity (e.g., “living off the land” attacks, “fileless” attacks, “malware-free” attacks, or the like). The security agent can, for instance, observe and analyze events that occur on the host device, and interact with the system to enable a detection loop that is aimed at defeating all aspects of a possible attack.

In some implementations, the security agent may be a kernel-level security agents or similar security application or interface to implement at least some of the techniques described herein. Such a kernel-level security agent may include activity pattern consumers that receive notifications of events in a query that meets query criteria. The kernel-level security agent may be installed by and configurable by the system, receiving, and applying while live, reconfigurations of agent module(s) and/or an agent situational model. Further, the kernel-level security agent may output query results to the system that include the security-relevant information, observing and sending detected activity to the system while the host device having the kernel-level security agent is powered on and running.

As applied to the techniques described herein, the system implemented as the cloud-based service may determine vector representations of labeled data entities, train a model with the vector representations, and provide the model or an indicator of attack obtained from the model to security agents at host devices to aid in detection of malicious activity.

The techniques described herein can increase the volume of data which can be analyzed by a security provider by reducing the computational cost (e.g. CPU usage or memory usage) in association with detecting malicious activity. For instance, telemetry data from a device (e.g., such as data captured in association with a fileless attack) can be processed in less time using a machine learned model, and results from the machine learned model can be used to notify the device (or other devices having similar characteristics as the device) of a potential attack.

The techniques described herein may be implemented in a number of ways. Example implementations are provided below with reference to the following figures. Although discussed in the context of a security system, the methods, apparatuses, techniques, and systems, described herein can be applied to a variety of systems (e.g., data storage systems, service hosting systems, cloud systems, and the like), and are not limited to security systems.

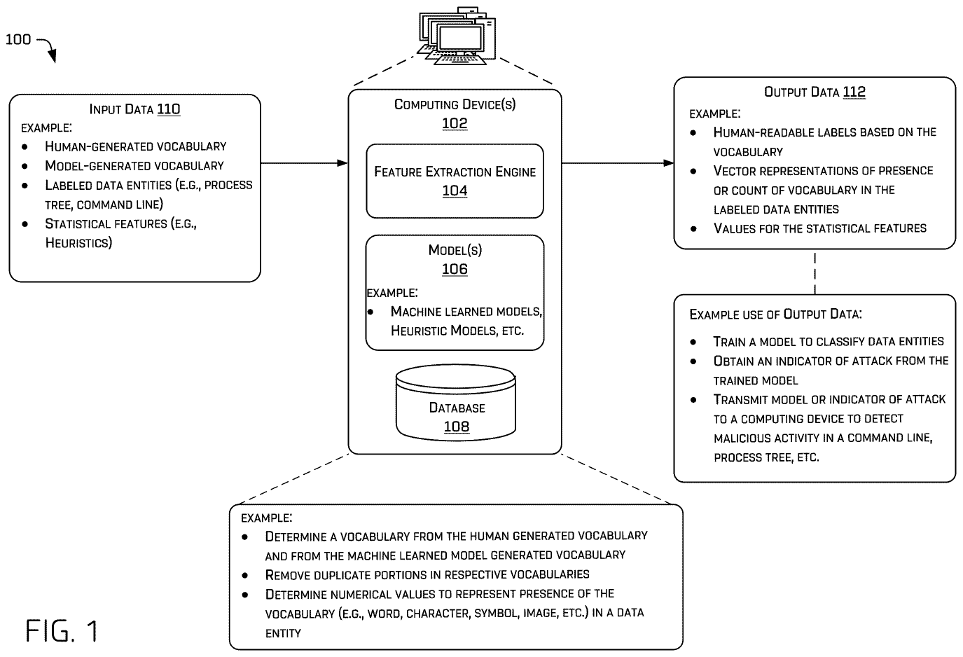

FIG. 1 illustrates a block diagram 100 of using a vocabulary, statistical features, and labeled data entities to determine vector representations of the labeled data entities and of using those vector representations to recognize malicious activity. The diagram 100 includes one or more computing device(s) 102 associated with a service system of a security provider. In various examples, the service system may be part of, or associated with, a cloud-based service network that is configured to implement aspects of the functionality described herein.

FIG. 1 depicts the computing device(s) 102 comprising a feature extraction engine 104, one or more models 106, and a database 108 to perform the functionality described herein. For instance, the computing device(s) 102 can implement one or more components and/or one or more models to receive input data 110 (e.g., human-generated vocabulary, model-generated vocabulary, statistical features, labeled data entities, etc.) and determine output data 112 (e.g., vector representations of labeled data entities, values of statistical features, human-readable labels, etc.).

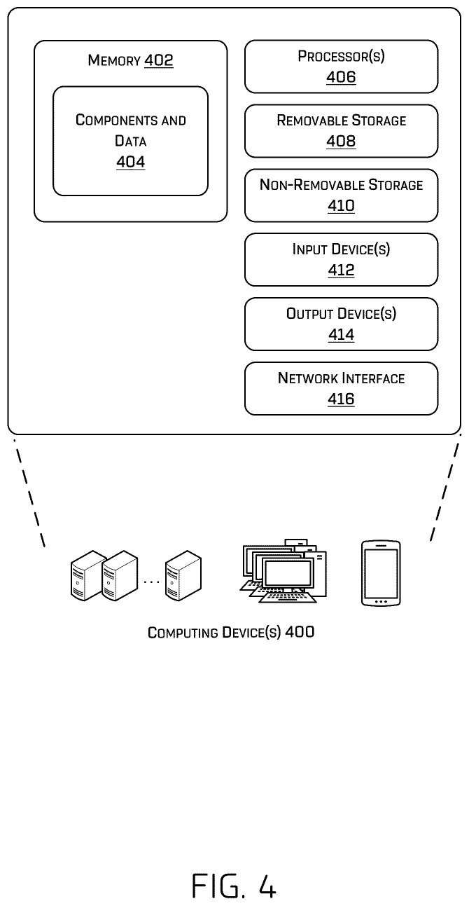

The computing device(s) 102 may be or include any suitable type of device, including, without limitation, a mainframe, a work station, a personal computer (PC), a laptop computer, a tablet computer, a personal digital assistant (PDA), a cellular phone, a media center, an embedded system, a robotic device, a wearable device (e.g., sunglasses, clothing, etc.), a vehicle, a Machine to Machine device (M2M), an unmanned aerial vehicle (UAV), an Internet of Things (IoT), or any other type of device or devices capable of implementing the feature extraction engine 104, model(s) 106, and database 108. An example of computing device(s) 102 is illustrated in FIG. 4 and described below in detail with reference to that figure.

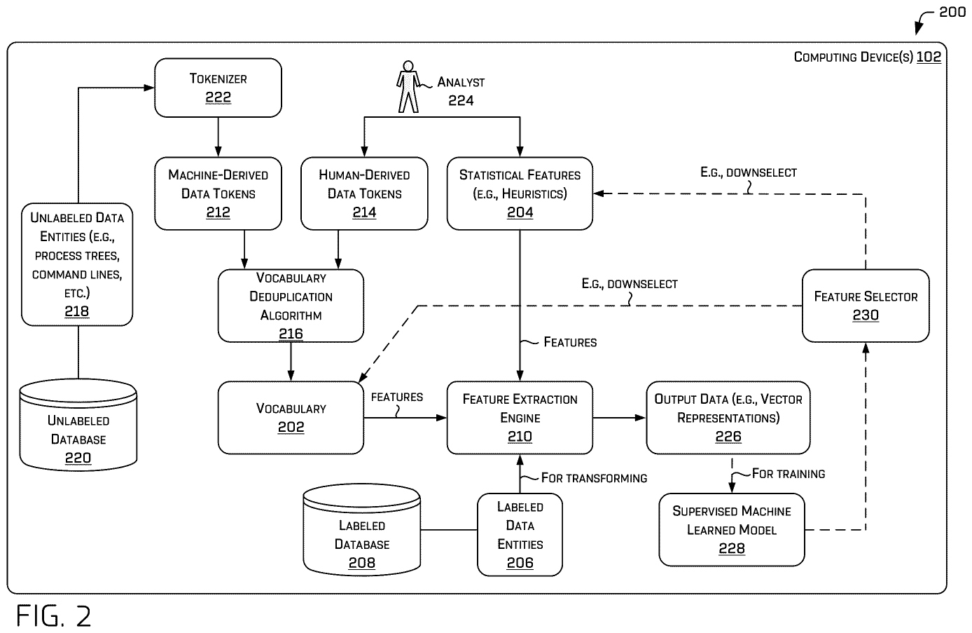

While FIG. 1 only shows the computing device(s) 102 having the feature extraction engine 104, the one or more models 106, and the database 108, the computing device(s) 102 may have any or all of the components and data shown in FIG. 2, and/or other components and data. Likewise, the model(s) 106 and database 108 may comprehend any of the components and data shown in FIG. 2 and/or any components and data that are useful to perform any aspect of the techniques described herein. For example, the input data 110 may be generated completely by components and data of the computing device(s) 102, completely provided to computing device(s) 102 from other sources, or partially received from other sources and partially derived from components and data of the computing device(s) 102.

Though depicted in FIG. 1 as separate components of the computing device(s) 102, functionality associated with the feature extraction engine 104 and/or the model(s) 106 can be included in a different component or model of the service system, a single component (or single model), or be included in a host device. In some instances, the components described herein may comprise a pluggable component, such as a virtual machine, a container, a serverless function, etc., that is capable of being implemented in a service provider and/or in conjunction with any Application Program Interface (API) gateway.

In various implementations, the human-generated vocabulary of the input data 110 may include human-derived data tokens received from a human security analyst. The human security analyst can be a data scientist, a machine learning engineer, a threat analyst, or the like associated with an organization responsible for the computing device(s) 102. Such a human security analyst may enter the human-derived data tokens into a user interface provided by the computing device(s) 102 or by another device. In some implementations, the user interface can also be configured to receive data for output on a display device, e.g., to validate data with the human security analyst. Further, the data tokens from the human security analyst can include both samples associated with malicious activity and other samples that do not necessarily represent malicious activity.

In various implementations, the machine-generated vocabulary of the input data 110 includes machine-derived data tokens generated by a tokenizer from unlabeled data entities represented in one or more models (e.g., model(s) 106) and/or stored in a database (e.g., database 108). The tokenizer may also be among the model(s) 106 or may be a separate component. As noted, the machine-derived data tokens may be generated based at least in part on an unsupervised algorithm.

The unlabeled data entities that the machine-generated vocabulary is generated from can represent data included in or otherwise associated with a data entity such as command line data that has not been classified as “malicious”, for example. Though described in relation to unlabeled data entities, the unsupervised algorithm may be applied to labeled data entities, depending on examples.

In further implementations, the labeled data entities of input data 110 may be represented by a model 106, stored in the database 108, or both. As noted elsewhere herein, the labeled data entities include not only data entities with labels such as “malicious” or “unwanted”, but also data entities with labels such as “clean” in order to allow for a more complete set of vector representations and better supervised machine learning model. In some implementations, the “labeled data entities” of the input data 110 may include unlabeled data associated with a data entity (e.g., data for analyzing to determine presence of a malicious event).

Along with the vocabularies and labeled data entities, the input data 110 may include statistical features (not shown). The statistical features can represent statistics or other features associated with a command line, process tree, or other data entity. In various examples, a model and/or a user can indicate statistical features such as a length of the data entity (e.g., a length or amount of data in a command line), or a part of a data entity; a number of alphanumeric character strings (e.g., words) in a data entity or in a part of a data entity; an average length, a minimum length, a maximum length, or a standard deviation of length of substrings (e.g. separated by whitespace) in a data entity or in a part of a data entity; a ratio of digits to alphanumeric characters in a data entity or in a part of a data entity; a number of substrings associated with a data entity (e.g., a number of characters separated by white space) or a part of a data entity; a ratio of digits and counts; a ratio of one type of character to all characters in a data entity or in a part of a data entity; a ratio of alphanumeric characters to total length of characters in a data entity or in a part of a data entity; etc.

In some implementations, either before the input data 110 is received or afterwards, duplicate data tokens belonging to both the human-generated vocabulary and the machine-generated vocabulary may be reduced/deduplicated to create a single or “joint” vocabulary. It is this “joint” vocabulary, along with the labeled data entities and the statistical features, that are input to the feature extraction engine 104, which in turn produces the output data 112.

In various implementations, the feature extraction engine 104 can receive the input data 110 and generate vector representations of the labeled data entities and their associated human-readable labels based on determining which data tokens of the vocabulary appear in the labeled data entities. For example, a vector representation of a labeled data entity could be [0, 0, 1, 1, 0, 0, 0, 1, 1, 1] with “1” representing presence and “0” representing absence of a data token of the vocabulary. The vector representations may represent presence, counts of data tokens, or both. These vector representations are output by the feature extraction engine 104 as output data 112. These vector representations for different data entities can be used to train a machine learned model (e.g., a supervised machine learned model) for use in classifying data entities arising in data transactions as malicious activity, as clean, as unwanted, etc.

In various implementations, the output data 112 includes vector representations of labeled data entities, values of statistical features, human-readable labels, etc., and is either distributed as is, for use by other components, models, or data of the computing device(s) 102, host devices, or other devices, or is input to one or more models (such as neural networks), or used to learn one or more decision trees. If input to one or more models, such models (which may be among model(s) 106) may be supervised machine learned models that are trained with the output data 112. In some implementations, the computing device(s) may then obtain indicator(s) of malicious activity (also referred to herein as indicators of attack). These model(s) (e.g., neural network(s), decision tree(s), logistic regression(s), etc.) and/or indicator(s) of malicious activity may then be distributed for use by other components, models, or data of the computing device(s) 102, host devices, or other devices. The recipient devices may then utilize the model(s) and/or indicator(s) of malicious activity to detect malicious activity in unlabeled data entities (command lines, process trees, etc.) received by those devices.

In addition to its use(s) (or alternatively to those use(s)), the output data 112 can be added to a catalog of security information (e.g., trained models or decision trees, indicators of malicious activity, etc.) for later distribution (in whole or in part) to host devices for use in detecting malicious activity. In some examples, upon producing the output data 112, a user (e.g., the human security analyst, etc.) and/or a model can verify accuracy of the output data 112 and/or update the output data 112 prior to and/or after its being included in the catalog.

FIG. 2 illustrates a diagram of an example security architecture 200 for using a vocabulary, statistical features, and labeled data entities to determine vector representations of the labeled data entities and to use those vector representations to recognize malicious activity. As illustrated, a vocabulary 202, statistical features 204, and labeled data entities 206 from a database 208 of labeled data entities (hereinafter, labeled database 208) are input to a feature extraction engine 210.

The vocabulary 202 may include machine-derived data tokens 212 and human-derived data tokens 214, both having been filtered through a vocabulary deduplication algorithm 216. In some examples, the machine-derived data tokens 212 and human-derived data tokens 214 can represent strings of characters that do not necessarily represent indicators of malicious activity. For example, the machine-derived data tokens 212 and human-derived data tokens 214 can include generic words, names of binaries, names of options, etc. The machine-derived data tokens 212 and human-derived data tokens 214 can represent, for example, individual characters or sequences of characters which may (or may not) represent an alphanumeric value, portion of a word, one or more numbers, etc.

The machine-derived data tokens 212 may be generated from unlabeled data entities 218 taken from a database 220 of unlabeled data entities (hereinafter, unlabeled database 220) and processed by a tokenizer 222. In various examples, the machine-derived data tokens 212 can be generated based at least in part on applying an unsupervised algorithm to the unlabeled data entities 218. For example, the unsupervised algorithm be used to generate a dataset of characters previously associated with a command line, a process tree, or the like.

The tokenizer 222 may be trained on a relatively large corpus of labeled and/or unlabeled command lines, process trees, or other entities. In other words, the tokenizer 222 may be trained using training data that does not include a label (e.g., malicious or benign) to split a command line (or other entity) into a series, set, or sequence of characters (e.g., words, numerals, etc. which may also be referred to as “data tokens”). In this way, the machine-derived data tokens 212 can represent characters (e.g., a hierarchy of characters, etc.) included in the unlabeled data entities 218.

The human-derived data tokens 214 may be provided by a human security analyst 224, who may also be a source of the statistical features 204. In some examples, the human security analyst 224 can provide data that becomes the human-derived data tokens 214 from a user interface associated with the human security analyst 224.

In some implementations, the statistical features 204 may be determined based at least in part on input from the analyst 224, though in other examples the statistical features 204 may also or instead be determined by a model independent of input from the analyst 224. Generally, the statistical features 204 can represent statistics or properties associated with a vocabulary and/or a data entity.

Based on this input data, the feature extraction engine 210 determines output data 226 (e.g., vector representations) and the output data 226 can be used for training a supervised machine learned model 228. In some examples, the output data 226 can represent numerical vectors for each entity such as 1) indicators or counts of vocabulary in each entity, 2) values of statistical features, and/or 3) labels associated with each entity associated with the labeled data entities 206.

In some examples, the feature extraction engine 210 can determine values for the statistical features 204 received as input. For example, the feature extraction engine 210 can analyze, scan, detect, or otherwise determine values for one or more statistical features 204 (e.g., counts of the occurrences of each data token 212/214 in the vocabulary 202 in a scanned command line, process tree, or the like).

Data output by the supervised machine learned model 228 can, for example, be used by a feature selector 230 as part of training (e.g., as indicated by dashed lines in FIG. 2). The feature selector 230 can, for example, determine level-of-importance (e.g., importance-based) features from the supervised machine learned model 228. Features from the feature selector 230 can, for instance, be used during training to downselect a statistical feature 204 and/or to downselect a data token included in the vocabulary 202.

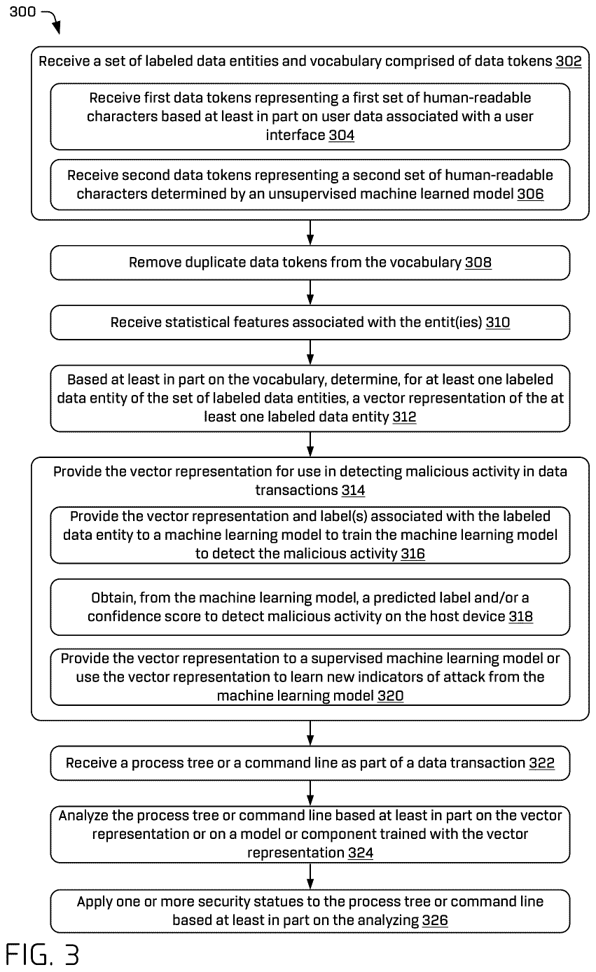

FIG. 3 illustrates an example process in accordance with examples of the disclosure. These process is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 3 is a flowchart depicting an example process 300 for determining, for a labeled data entity, a vector representation that is usable to recognize malicious activity. For example, some or all of process 300 may be performed by the computing device(s) 102 (or service associated therewith).

As illustrated at 302, a system having one or more processors may receive a vocabulary comprised of data tokens and a set of labeled data entities. At 304, the receiving includes receiving first data tokens representing a first set of human-readable characters. The first data tokens are determined based at least in part on user data associated with a user interface. At 306, the receiving further includes receiving second data tokens representing a second set of human-readable characters. The second data tokens are determined by a machine learned model configured to output the second data tokens based at least in part on an unsupervised algorithm.

At 308, the system may then remove duplicate data tokens from the vocabulary.

At 310, the system may receive statistical features associated with the data tokens. In some examples, the statistical features may include at least one of a length of a data entity; a length of a part of a data entity; a number of alphanumeric character strings in a data entity or in a part of a data entity; an average length, a minimum length, a maximum length, or a standard deviation of length of substrings (e.g. separated by whitespace) in a data entity or in a part of a data entity; a ratio of digits to alphanumeric characters in a data entity or in a part of a data entity; a number of characters associated with a data entity or a part of a data entity; a ratio of digits and counts; a ratio of one type of character to all characters in a data entity or in a part of a data entity; or a ratio of alphanumeric characters to total length of characters in a data entity or in a part of a data entity.

At 312, based at least in part on the vocabulary, the system determines, for at least one labeled data entity of the set of labeled data entities, a vector representation of the at least one labeled data entity. The vector representation indicates presence or counts of data tokens of the vocabulary within the at least one labeled data entity. In some examples, the vector representation includes numerical values corresponding to values of the statistical features for the data tokens indicated as present by the vector representation.

At 314, the system provides the vector representation for use in detecting malicious activity in data transactions. At 316, the providing comprises providing the vector representation and one or more labels associated with the at least one labeled data entity to a machine learning model to train the machine learning model to detect the malicious activity. At 318, the system may then obtain, from the machine learning model, a classification in the form of a predicted label and/or a confidence score, to detect malicious activity on the host device. In some implementations, the one or more labels may indicate corresponding one or more security statuses for the at least one labeled data entity and the vector representation may be associated with those one or more security statuses. In some examples, the one or more security statues may include at least one of a malicious status, a clean status, or an unwanted status. In further implementations, at 320, the providing may comprise providing the vector representation to at least one supervised machine learning model to determine, based on the supervised machine learning model(s), which combinations of the presence, count, and/or absence of tokens tend to be associated with malicious activity, for those combinations to be used as Indicators of Attack to flag potentially malicious activity in a data transaction. Those combinations can be represented, for example, as a decision tree or a (combination of) list(s).

At 322, the system may then receive a process tree or a command line as part of a data transaction.

At 324, the system may analyze the process tree or command line based at least in part on the vector representation or on a model or component trained with the vector representation.

At 326, the system may then apply one or more security statues to the process tree or command line based at least in part on the analyzing.

FIG. 4 is a block diagram of an illustrative computing architecture of the computing device(s) 400 to implement the techniques describe herein. In some embodiments, the computing device(s) 400 can correspond to the computing device(s) 102. It is to be understood in the context of this disclosure that the computing device(s) 400 can be implemented as a single device or as a plurality of devices with components and data distributed among them.

As illustrated in FIG. 4, the computing device(s) 400 comprises a memory 402 storing components and data 404. Also, the computing device(s) 400 is further shown to one or more processor(s) 406, a removable storage 408 and non-removable storage 410, input device(s) 412, output device(s) 414, and network interface 416.

In various embodiments, memory 402 is volatile (such as RAM), non-volatile (such as ROM, flash memory, etc.) or some combination of the two. The components and data 404 stored in the memory 402 can comprise methods, threads, processes, applications or any other sort of executable instructions, as well as models, files databases, etc. The various components and data of FIGS. 1 and 2 may be examples of components and data 404. Moreover, the computing device(s) 400 may be configured to run any compatible device operating system (OS), which may be among the components and data 404.

In various embodiments, the memory 402 generally includes both volatile memory and non-volatile memory (e.g., RAM, ROM, EEPROM, Flash Memory, miniature hard drive, memory card, optical storage, magnetic cassettes, magnetic tape, magnetic disk storage or other magnetic storage devices, or any other medium). The memory 402 may also be described as computer storage media or non-transitory computer-readable media, and may include volatile and nonvolatile, removable and non-removable media implemented in any method or technology for storage of information, such as computer readable instructions, data structures, program modules, or other data. Computer-readable storage media (or non-transitory computer-readable media) include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, and the like. Any such memory 402 may be part of the security service system.

In some instances, any or all of the devices and/or components of the computing device(s) 400 may have features or functionality in addition to those that FIG. 4 illustrates. For example, some or all of the functionality described as residing within any or all of the computing device(s) 400 may reside remotely from that/those computing device(s) 400, in some implementations.

The computing device(s) 400 also can include input device(s) 412, such as a keypad, a cursor control, a touch-sensitive display, voice input device, etc., and output device(s) 414 such as a display, speakers, printers, etc. These devices are well known in the art and need not be discussed at length here.

As illustrated in FIG. 4, the computing device(s) 400 also includes the network interface 416 that enables the computing device(s) 400 to communicate with other computing devices over, e.g., one or more communication networks. The computing device(s) 400 may be configured to communicate over a telecommunications network using any common wireless and/or wired network access technology.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed processes could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A system comprising:
one or more processors;
a user interface coupled to the one or more processors; and
one or more non-transitory computer-readable media storing computer-executable instructions that, when executed, cause the one or more processors to perform operations comprising:
receiving a joint vocabulary and a set of labeled data entities, the joint vocabulary generated by:
determining at least one first data token based at least in part on user data entered by way of the user interface, the at least one first data token being one or more human-interpretable characters,
determining at least one second data token by a tokenizer trained using unlabeled training data, and
combining the at least one first data token and the at least one second data token into the joint vocabulary;
based at least in part on the joint vocabulary, determining, for at least one labeled data entity of the set of labeled data entities, a vector representation of the at least one labeled data entity, the vector representation indicating presence or counts of data tokens of the joint vocabulary within the at least one labeled data entity; and
using the vector representation in detecting malicious activity in data transactions.

2. The system of claim 1, wherein the operations further comprise receiving statistical features associated with an entity and including, with the vector representation, numerical values corresponding to values of the statistical features for the entity.

3. The system of claim 2, wherein the statistical features include at least one of a length of a data entity; a length of a part of a data entity; a number of alphanumeric character strings in a data entity or in a part of a data entity; an average length, a minimum length, a maximum length, or a standard deviation of length of substrings separated by whitespace in a data entity or in a part of a data entity; a ratio of digits to alphanumeric characters in a data entity or in a part of a data entity; a number of characters associated with a data entity or a part of a data entity; a ratio of digits and counts; a ratio of one type of character to all characters in a data entity or in a part of a data entity; or a ratio of alphanumeric characters to total length of characters in a data entity or in a part of a data entity.

4. The system of claim 1, wherein:
the at least one second data token represents a set of human-interpretable characters, and
the tokenizer is configured to output the at least one second data token based at least in part on an unsupervised algorithm.

5. The system of claim 1, further comprising removing duplicate data tokens from the joint vocabulary.

6. The system of claim 1, wherein using the vector representation comprises providing the vector representation and one or more labels associated with the at least one labeled data entity to a machine learning model to train the machine learning model to detect the malicious activity.

7. The system of claim 6, wherein using the vector representation further comprises providing at least one of the vector representation, the machine learning model, or the indicator or attack to a host device to detect malicious activity on the host device.

8. The system of claim 6, wherein the one or more labels indicate one or more security statuses for the at least one labeled data entity and the vector representation is associated with the one or more security statuses.

9. The system of claim 8, wherein the one or more security statuses include at least one of a malicious status, a clean status, or an unwanted status.

10. The system of claim 1, wherein the providing comprises providing the vector representation to a supervised machine learning model or using the vector representation to learn new indicators of attack from the machine learning model.

11. The system of claim 1, further comprising:
receiving a process tree or a command line as part of a data transaction;
analyzing the process tree or command line based at least in part on the vector representation or on a model or component trained with the vector representation; and
applying one or more security statues to the process tree or command line based at least in part on the analyzing.

12. A method comprising:
receiving, by one or more computing devices, a joint vocabulary and a set of labeled data entities, the joint vocabulary generated by:
determining at least one first data token based at least in part on user data entered by way of a user interface, the at least one first data token being one or more human-interpretable characters,
determining at least one second data token by a machine learned model, the at least one second data token representing a hierarchy of characters included in an unlabeled data entity, and
combining the at least one first data token and the at least one second data token into the joint vocabulary;
based at least in part on the joint vocabulary, determining for at least one labeled data entity of the set of labeled data entities, by the one or more computing devices, a vector representation of the at least one labeled data entity, the vector representation indicating presence or counts of data tokens of the joint vocabulary within the at least one labeled data entity; and
using, by the one or more computing devices, the vector representation in detecting malicious activity in data transactions.

13. The method of claim 12, further comprising receiving statistical features associated with an entity and including, with the vector representation, numerical values corresponding to values of the statistical features for the entity.

14. The method of claim 12, wherein:
the at least one second data token represents a set of human-interpretable characters, and
the machine learned model is configured to output the at least one second data token based at least in part on an unsupervised algorithm.

15. The method of claim 12, wherein using the vector representation comprises providing the vector representation and one or more labels associated with the at least one labeled data entity to a machine learning model to train the machine learning model to detect the malicious activity.

16. The method of claim 15, wherein using the vector representation comprises providing at least one of the vector representation, the machine learning model, or an indicator of attack obtained from the machine learned model to a host device to detect malicious activity on the host device.

17. The method of claim 12, further comprising:
receiving a process tree or a command line as part of a data transaction;
analyzing the process tree or command line based at least in part on the vector representation or on a model or component trained with the vector representation; and
applying one or more security statues to the process tree or command line based at least in part on the analyzing.

18. A non-transitory computer storage medium having programming instructions stored thereon that, when executed by one or more processors of a system, cause the system to perform operations comprising:
receiving a joint vocabulary and a set of labeled data entities, the joint vocabulary generated by:
determining at least one first data token based at least in part on user data entered by way of a user interface, the at least one first data token being one or more human-interpretable characters,
determining at least one second data token by a machine learned model, the at least one second data token representing a hierarchy of characters included in an unlabeled data entity, and
combining the at least one first data token and the at least one second data token into the joint vocabulary;
based at least in part on the joint vocabulary, determining, for at least one labeled data entity of the set of labeled data entities, a vector representation of the at least one labeled data entity, the vector representation indicating presence or counts of data tokens of the joint vocabulary within the at least one labeled data entity; and
using the vector representation in detecting malicious activity in data transactions.

19. The non-transitory computer storage medium of claim 18, wherein the operations further comprise receiving statistical features associated with an entity and including, with the vector representation, numerical values corresponding to values of the statistical features for the entity, at least one of the statistical features being received as part of the user data associated with the user interface.

20. The non-transitory computer storage medium of claim 18, wherein:
the at least one second data token represents a set of human-interpretable characters, and
the machine learned model is configured to output the at least one second data token based at least in part on an unsupervised algorithm.
